(19) United States
(12) Patent Application Publication
(10) Pub. No.: US 2024/0128893 A1
(43) Pub. Date: Apr. 18, 2024

(54) SYSTEM FOR GENERATING MOVEMENT OF ITEMS IN A SPECIFIC PATTERN

(71) Applicant: Scott C. Sperry, Dallas, TX (US)

(72) Inventor: Scott C. Sperry, Dallas, TX (US)

(21) Appl. No.: 18/482,812

(22) Filed: Oct. 6, 2023

Related U.S. Application Data
(63) Continuation of application No. 15/691,092, filed on Aug. 30, 2017, now abandoned.
Application No. 15/691,092 is a continuation of application No. PCT/US2016/019959, filed on Feb. 26, 2016.
(60) Provisional application No. 62/298,136, filed on Feb. 22, 2016.
(60) Provisional application No. 62/126,684, filed on Mar. 1, 2015.
(60) Provisional application No. 62/163,339, filed on May 18, 2015.

(51) Int. Cl. H02N 1/00; F03G 7/10; H02N 11/00

(52) U.S. Cl. CPC H02N 1/004; F03G 7/135; H02N 11/008; H02P 7/343

(57) ABSTRACT

According to an embodiment of the disclosure, a method of moving an item in a torus-like infinity pattern is provided. The method includes moving the item poloidally along a path with reference to a torus grid at least partially moving the item toroidally along the path with reference to the torus grid such that when the item substantially moves around a revolution around the torus grid when viewed from a cross section cut across the poloidal direction of movement, the item also moves poloidally.

### PRIORITY APPLICATIONS

This application is a continuation of U.S. application Ser. No. 15/691,092 filed Aug. 30, 2017, which is a continuation of PCT Application No. PCT/US16/19959 filed on Feb. 26, 2016, which claims priority to U.S. Provisional Application No. 62/298,136 filed on Feb. 22, 2016; U.S. Provisional Application No. 62/126,684 filed on Mar. 1, 2015; and U.S. Provisional Application No. 62/163,339 filed on May 18, 2015. Each of these applications is incorporated by reference herein for all purposes.

### TECHNICAL FIELD

This disclosure is generally directed to systems that move items in a pattern to manipulate forces such as gravity and inertia. More specifically, this disclosure is directed to the movement of items in a specific pattern.

### BACKGROUND

The movement of objects can help manipulate forces such as gravity and inertia, for example, to stabilize a structure. For example, U.S. Pat. No. 3,034,745 describes spin axis stabilization for space vehicles that have a ring with internal raceways. The center of gravity for these space vehicles changes relative to the spin axis of the rings.

Likewise, U.S. Pat. No. 5,139,217 describes stabilization of a moving object through paths of movements of items.

### SUMMARY OF THE DISCLOSURE

According to an embodiment of the disclosure, a method moves an item in a pattern. The method includes moving the item poloidally along a curvilinear path with reference to a torus topological grid at least partially moving the item toroidally along the path with reference to the torus topological grid such that when the item substantially moves around a revolution around the torus topological grid when viewed from a cross section cut across the poloidal direction of movement, the item also moves poloidally.

According to another embodiment of the disclosure, a system moves an item in a torus-like infinity pattern. The system includes a channel that moves the item poloidally along a path with reference to a torus topological grid at least partially moving the item toroidally along the path with reference to the torus topological grid such that when the item substantially moves around a revolution around the torus topological grid when viewed from a cross section cut across the poloidal direction of movement, the channel also moves the item poloidally.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. The phrase “at least one of,” when used with a list of items, means that different combinations of one or more of the listed items may be used, and only one item in the list may be needed. For example, “at least one of: A, B, and C” includes any of the following combinations: A; B; C; A and B; A and C; B and C; and A and B and C. Definitions for certain words and phrases are provided throughout this patent document, those of ordinary skill in the art should understand that in many if not most instances, such definitions apply to prior, as well as future uses of such defined words and phrases.

Various embodiments may have one or more (or none) of the following features:
A system, method, and device for generating the torus pattern.
A system and method that generates the pattern with rotational inertias or angular momentums.
A system and device that is a gyroscope with a linear axis.
A system, and method for producing a gyroscope with a linear axis.
A device, method, and system for converting rotational inertia into linear movement through a rotational drive.
A device and system that converts linear inertia into rotational inertia through a vortex drive.
A device, method, and system for a reactionless drive.
A system, method, and device for expanding and contracting space time and gravity.
A device that operates within at least two temporal dimensions simultaneously (4D+4D).
A method and system for modeling systems after the torus.
A device and system that is designed to enlighten, entertain, and educate.

### BRIEF DESCRIPTION OF THE DRAWINGS

For a more complete understanding of this disclosure and its features, reference is now made to the following description, taken in conjunction with the accompanying drawings where like numbers reference like parts in which:

FIG. 1A shows a bottom-side view of a basic torus shape with topological grid space;

FIGS. 1B, 1C, and 1D show a cross section for example, cut across a plane of the poloidal movement of the torus topological grid;

FIG. 1E shows a top side view of a basic torus shape with a superimposed curvilinear topological movement matrix.

FIGS. 2A through 2E, FIG. 3 and FIG. 4A-4C show an InfinityScrew, according to an embodiment of the disclosure;

FIG. 5 shows the VortexScrew, according to an embodiment of the disclosure;

FIG. 6 shows a bottom view of the InfinityScrew, radial end bracket removed;

FIG. 7 shows a cross-sectional view of the InfinityScrew;

FIG. 8 shows a cross-sectional view of the InfinityScrew;

FIG. 9 shows a side view of the InfnityScrew securing cuff bracket;

FIG. 10 shows a front or top view of the InfinityScrew, radial end bracket removed;

FIG. 11 shows a lengthwise cross-sectional view of the InfnityScrew engine securing cuff and securing cuff bracket;

FIG. 12 shows the radial end bracket with redirectors;

FIG. 13 shows a multi-tooth redirector.

FIG. 14 shows a cross-sectional view of the InfinityScrew; and

FIGS. 15 and 16 show spoke-tube segments.

### DETAILED DESCRIPTION

The FIGURES described below, and the various embodiments used to describe the principles of the present disclosure in this patent document are by way of illustration only and should not be construed in any way to limit the scope of the disclosure. Those skilled in the art will understand that the principles of the present disclosure invention may be implemented in any type of suitably arranged device or system. Additionally, the drawings are not necessarily drawn to scale. Moreover, no claim is made to any of the systems or methods creating a supernatural phenomenon.

Some of the disclosures presented herein are modeled after a torus. The two high-level disclosures referred to herein as the InfinityScrew and the InifrmyMatrix are torus pattern generators. It should be noted that while certain embodiments of such disclosures will be described as having certain qualities, not every embodiment will necessarily have such qualities. Rather, certain embodiments will have some, none, or all of the qualities described with reference to other embodiments.

### InfinityScrew

One embodiment of the disclosure presents the InfinityScrew, which generates a torus pattern. The InfinityScrew is so-named because, according to one embodiments, its spheres (the angular momentums or rotational inertias) trace an “infinity” pattern as the engine rotates, as exampled by the “infinity” sphere tube pattern, which is actually one continuous length, looped or twisted around to form multiple infinity patterns, each radiating outward from the shared central z-axis. During InfinityScrew rotation, spheres are flowing synchronistical and single-file through the sphere-tube infinity matrix. Poloidal redirectors, which facilitate movement of the spheres along the z-axis, make this possible during rotation. During both expansion and contraction phases the rotation direction is the same, always clockwise from the top view or counterclockwise from the bottom view. When rotating, its spheres (inertias) travel an endless “infinity” loop through the engine, looping back and forth along the axis in simultaneous toroidal and poloidal combination, expanding up, outward, and away from the zero-point/axis, and then contracting back inward towards the axis while still rotating around and along it. When spheres reach the end of one direction, they make a U-turn and head back the other way in the opposite phase of entropy. Expansion through rotation always returns to contraction (through the same direction of rotation) and then back again to expansion—over and over, in harmony.

The combination of toroidal and poloidal movements generates a sustainable torus rotational inertia pattern—one that can keep going without colliding with itself.

Although spheres are described as one “thing” that follow the infinity pattern in one embodiment, yet other “things” may also follow the pattern as will become apparent to one of ordinary skill in the art after review of the specification. As non-limiting examples, fluids (gas or liquids) and electrons may also be used for movement of a things in the infinity pattern as described below with reference to embodiments with the InfinityMatrix disclosure.

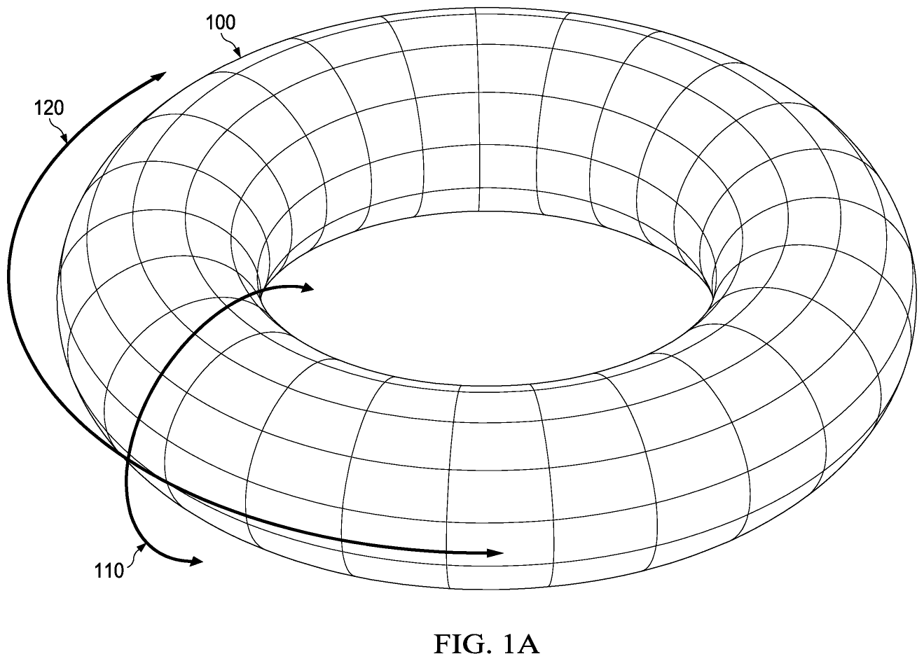

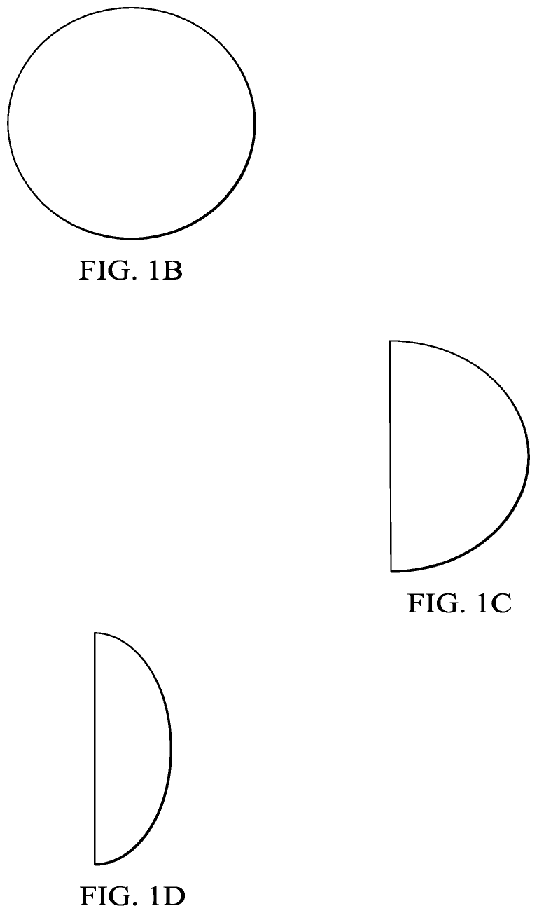

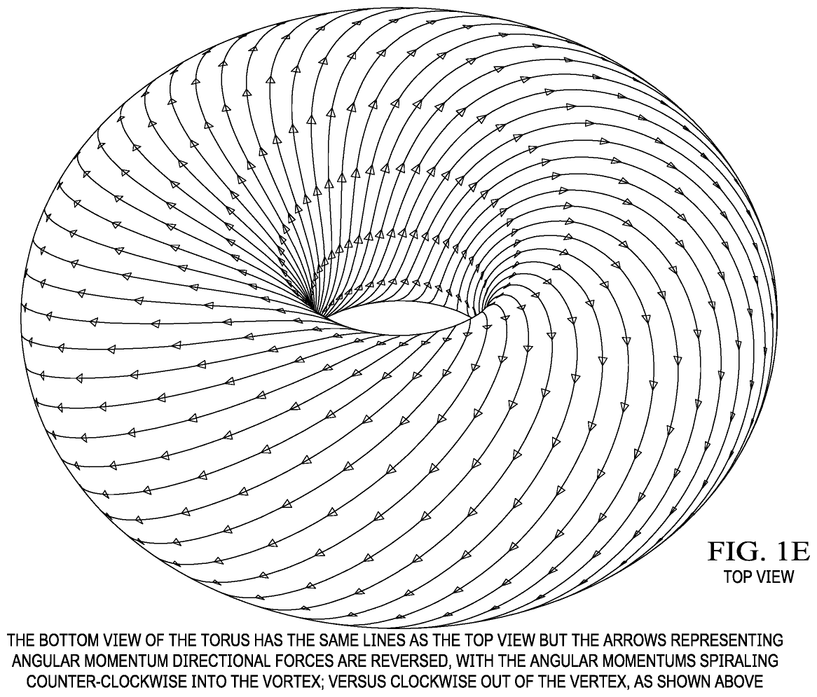

FIG. 1A shows a bottom-side view of a basic torus shape or grid 100, which some may equate to a donut. As described herein, poloidal movement generally refers to movement in the direction of arrows 110 whereas toroidal movement is in the direction of arrow 120 with reference to the torus grid. According to some embodiments of the disclosures, movement of matter or energy in a combination of poloidal or toroidal directions yields certain advantages described below. While the term “grid” has been used herein, it should be understood that a “grid” need not be physical thing and is rather used to define how other objects move. Some may view such a grid as a spatial identifier.

FIG. 1B is a cross section for example, cut across a plane of the poloidal movement of the torus grid 100. FIG. 1B shows a generally circular shape. FIG. 1C shows one side of the circular shape being flattened whereas FIG. 1D shows a flattening of the curvilinear shape. With reference to a “torus” pattern herein, it should be understood that poloidal movement need not follow a circle and can instead follow shapes such as those shown in FIGS. 1C and 1D. Further details of such movement in a torus pattern are described below.

Whereas FIG. 1A shows a static view, FIG. 1E shows a top side view of a basic torus shape with a superimposed curvilinear topological movement matrix to show how items are moving with respect to the grid.

### Anatomical Analogies of InfinityScrew

### Axis Circuit (Spinal Cord)

The axis circuit 210 (or spinal cord) is that which moves electrical charge through its vortex line or spinal column 220. Electrical charge through the axis circuit 210 animates the body along the length of its entire nervous system, including its appendages. Life only happens around a charged axis. The axis circuit 210 is fixed within the conduit of the shaft 220 (a hollow spinal column).

### Shaft (Spinal Column)

The shaft 220 (or spinal column) is the hollow tubular encasement that contains and protects the axis circuit 210 or spinal cord of the InfinityScrew.

The core of the shaft 220 is hollow like a spinal column or an electrical conduit, enabling electrical wires to be slid through and positioned within. This conduit in the core of the shaft contains and protects the charge-carrying spinal cord or axis-circuit.

The IS engine rotates around the shaft 220 clockwise from the top view or counter-clockwise from the bottom view. These are just different perspectives, not different spins.

The shaft 220 of the IS engine is fixed and secured by the radial end-bracket(s) 280 at one or both ends, depending on the specialization of the engine. The securing cuff bracket 230, which holds the rotating engine or the moving piece, slides over the fixed shaft 220 and is secured to the fixed shaft 220.

The shaft 220 of the InfinityScrew can be any size, but in particular embodiments, it is fixed and encases an axis circuit 210. In particular embodiment, the shaft 220 holds the rotating engine from within by the securing cuff bracket 230.

### Securing Cuff Bracket (Spine)

The securing cuff bracket 230 is the anatomical parallel to the spine. It is the rigid tubular encasement that protects the shaft 220 (spinal column) and the axis circuit 210 (spinal cord). The securing cuff bracket secures around the shaft 220 (spinal column), giving it greater strength and rigidity, and further protecting the axis circuit/vortex line/spinal cord. The securing cuff bracket secures the rotating (or moving) part of the InfinityScrew engine to the fixed shaft/spinal column. In particular configurations, the securing cuff bracket 230 has a grooved or threaded interior that slides/screws perfectly over the grooved exterior of the shaft 220, securing the securing cuff bracket 230 to the shaft with ease 220. This ensures no slippage of the securing cuff 20 bracket around/along the fixed shaft when thrust forces are generated. In particular configurations, only the securing cuff 250 is meant to rotate around the shaft 220. The securing cuff bracket 230 is not meant to rotate. The securing cuff bracket 230 is the fixed tubular platform around which the securing cuff 250 rotates.

A TeleScrew securing cuff bracket is the larger, and relatively fixed, host tube in which the TeleScrew works. Each Tele Screw is contained within another's tube-shaft (inversion). TeleScrews are often hexagonal or round, meaning they have hexagonal or round securing cuff brackets and securing cuffs. Tele Screw securing cuff brackets are always fixed relative to their securing cuffs. They are the fixed platforms for their guest tubes. A securing cuff for one may contain a myriad of smaller securing cuffs (and securing cuff brackets) nested or embedded within each other.

A CircleScrew securing cuff bracket (shoulder girdle or hip girdle) is often hexagonal and hollow tubular as well. It slides or screws into its engine bracket, which becomes synonymous with the hollow shaft—secured, fixed, and non-moving.

### Securing Cuff Sphere-Bearings (Vertebrae or Ribs)

Securing cuff sphere bearings 240 are the anatomical equivalent of vertebrae, or ribs which are like lateral extensions of the vertebrae. They are the multiple ring-like joints that are stacked above one another around the spinal column, enabling the shoulders and hips to smoothly rotate around the spinal column and spine. Unlike the spheres 260 in the sphere tubes, which are for creating the required angular momentums, the securing cuff sphere bearings 240 are there for frictionless rotation. Their linear inertias are not affecting the torus pattern created by the spheres 260 in the spoke tubes. The rings of securing cuff sphere bearings 240 in circular races 232 between the securing cuff bracket 230 and the securing cuff 250 enable the securing cuff 250 to rotate around the securing cuff bracket 230 with minimal friction.

The securing cuff sphere bearings 240 can be injected into circular races 232 between the securing cuff bracket 230 and the securing cuff 250 where they fill the ringed races 232. This enables for minimal clearance space between the rotating securing cuff 250 and the fixed securing cuff bracket 230. This ring-race design also enables one bearing system to handle all bearing stabilization efforts, including serving as thruster bearings that enables the securing cuff bracket 230 to handle the thrust forces generated along the z-axis. One may view such a configuration as an all smooth and safe securing cuff movement around the securing cuff bracket 230.

On a TeleScrew the securing cuff sphere bearings are positioned within the securing cuff bracket, along its tubular length, occupying the corners of the hexagon along its interior lengths. These sphere bearings are both for frictionless extension, as well as for the SuperScrew threads to grab and drive the Tele Screw in and out of its host tube (securing cuff bracket).

On a CircleScrew the securing cuff sphere bearings are embedded or inserted between the securing cuff bracket and the rotating securing cuff piece. They are also found embedded within the securing cuff rim, where SnailScrews press against them and drive them around in circles through the screwing of their SuperScrew threads over the sphere bearings. The sphere bearings of Circle Screws are embedded in concentric bearing brackets and resemble ribs more than vertebrae.

Sphere bearings are for the redirection of rotational inertias, as are SnailScrews. Redirection is symbolized by the number 3 and, hence, torus redirectors are always triangular in shape, as triangles are 3-sided. Therefore, sphere bearings are also presented in triangular placements. This is accomplished by simply putting the races together so that the spheres are in two or more tightly concentric races or brackets. In certain embodiments, the spheres line up in a way that produces a 45-degree thread wedge angle between them, enabling the SuperScrew driver, also with a 45-degree thread wedge angle, to drive into them and against them for traction. This triangular sphere placement design naturally accommodates drive in either direction over the bearings, whether around and around in circles, or up and down in a TeleScrew.

### Securing Cuff (Shoulder-Scapula or Hip Socket)

The securing cuff 250 is the anatomical equivalent of the shoulder/scapula or the hip socket that secures the arm or leg to the body and spine and enabling the appendage to move around and along the axis. Shoulders and hips are outside the ribs and rotate around the ribcage and spine.

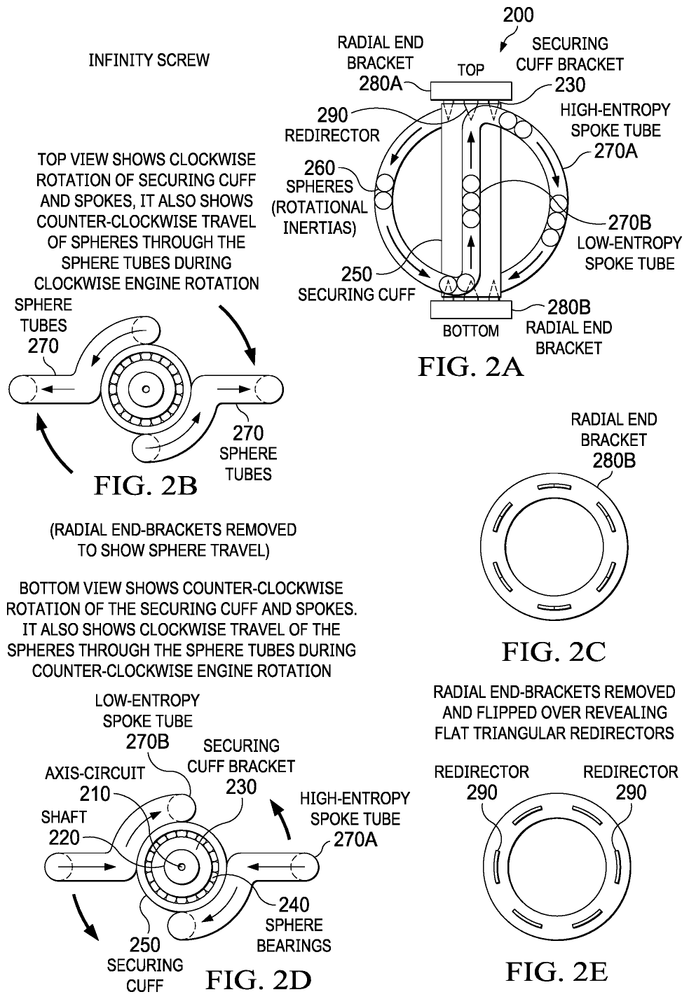

The securing cuff 250 is the rotating or moving part of the engine and produces engine rotation around the shaft 220. The securing cuff 250 works together with the securing cuff bracket 230 similar to a sleeve bearing. In particular configurations, the securing cuffs 250 may be hexagonal; in other configurations, the securing cuffs 250 may be other shapes. The spokes (or spoke tracks), which are not necessarily seen in FIGS. 2A-2F are embedded in the securing cuff 250 and hold the spoke tubes to the securing cuff.

Some securing cuffs 250, like those found in the GreenGiants and SkyWays, are massive and segmented for easy handling. Securing cuffs 250 are typically rotary, but as we've seen with the TeleScrew, the securing cuff 250 can also move in a linear fashion.

The TeleScrew securing cuff is the piece that slides in and out of the host tube (or securing cuff bracket.) It is driven from within its base by a SuperScrew, lifting it up and down.

A Circle Screw securing cuff is easily remembered as the piece that rotates against the CircleScrew and the securing cuff bracket (hip- or shoulder-girdle) in which the CircleScrew is embedded.

### Radial End-Brackets (Collarbone and Pelvis)

The radial end-brackets 280A, 280B are the anatomical equivalents of the collarbone and pelvis. The radial end-brackets 280A, 280B are the ring-like securing parts that encircle and secure to the exterior of the spine, at the top and bottom of the torso (torus), adding rigidity to the spine, while stabilizing and bracing for the rotation of the body. When the body rotates, it rotates from above the pelvis or from below the shoulders. In order to rotate, the body needs something to rotate against. Every body must either secure with its lower body and rotate from above the hips (like a boxer or an axe man), or it must secure with its upper body and rotate from below the shoulders (like a cyclist). When secured by both the upper and lower body, how can rotary movement occur? It wouldn't be possible unless the upper and lower could coordinate opposing inertias, which they can. Ice skaters and dancers do.

The radial end-brackets 280A, 280B are connected to one another by the securing cuff bracket 230, around which they both attach. Sometimes, one or both of the radial end-brackets 280 is embedded within the engine, hidden beneath an engine extension or tail.

Radial end-brackets 280A, 280B hold the redirectors in place, next to each end of the rotating securing cuff 250. The radial end-brackets 280A, 280B do not rotate because they are fixed to the securing cuff bracket 230, which also does not rotate. Radial end brackets 280A, 280B sandwich the rotational piece (securing cuff 250) and hold the redirectors 290 on their inertia-10 facing sides and are reflections of one other. This ensures that spheres 260 are exiting the sphere tubes 270 at the same pace they are being added to the sphere tubes 270 to ensure harmony and balance within the system.

The radial end-brackets 280A, 280B do not touch the rotating IS engine. The redirectors 290, however, do touch the spheres 260 or inertia generators as the engine rotates, nudging the spheres 260 into outgoing sphere tubes by way of little flat channels through the end curves of the sphere tubes. These redirectors are fixed to the radial end brackets and serve to keep the engine in dynamic inertial harmony. This means keeping the spheres moving smoothly and evenly throughout the sphere tube infinity matrix of the IS engine during rotation.

In particular configurations, radial end-brackets 280A, 280B are ring-shaped, fixed, and contribute to the redirection of rotational inertias, passively redirecting inertia as the inertia sweeps by it.

A Tele Screw radial end-bracket contains the movement of the securing cuff. It is located in the base and around the neck of the host tube. Each screws or slides on to the securing cuff bracket at its ends. The TeleScrew radial end-brackets keep the securing cuff safely contained within the tube.

CircleScrew radial end-brackets sandwich the rotating securing cuff between themselves. The two radial end-brackets contain the ends of the rotating piece—the top and bottom, or the inner and outer, or the front and the rear. One of the radial end brackets attaches to the securing cuff bracket (or engine bracket), and the other usually attaches atop the circle of SnailScrews that 30 make up the CircleScrew that drives the securing cuff. This second radial end bracket is usually a brass annulus ring, anatomically symbolic of the soft-tissue torso that holds the two halves of the body together while enabling rotation between the two. A brass annulus ring is also designed to dissipate pressure shockwaves between the front and the rear (or top and bottom) of the CircleScrew—around the torso. The annulus ring (radial end bracket) is always secured to the securing cuff bracket and contains the top or bottom of the rotating engine.

### Redirectors (Hearts and Stomachs)

The redirectors 290 redirect rotational inertia in order to keep those inertias moving throughout the system in the described torus pattern, keeping the system alive. Hearts and stomachs redirect inertia, too, namely electrical inertia in the form of blood and nutrients. The redirectors 290 redirect the rotational inertias from the spheres 290 all throughout the sphere tube 270 matrix, which is one long sphere tube wrapped in an InfinityMatrix-like pattern and fixed atop spokes, alternating high- and low-entropy.

The heart has a triangular shape—a triangle has 3 sides. The redirectors 290 are triangular in shape and produce a 3-phase (up, down, and pause) effect when inertia moves over them. While redirectors 290 of the InfinityScrew in this configuration are triangular; however, they may have different shapes in other configurations. The redirectors 290 redirect rotational inertias into pathways headed in the other direction along the axis into outgoing sphere tubes 270. Sandwiching each end of the rotating piece, the redirectors 290 work together, in sync, to maintain a dynamic inertial harmony within the engine. As one sphere 260 is added to a sphere tube, simultaneously another sphere 260 is redirected out of that sphere tube, so that information can “flow” in sync.

The redirectors 290 make displacement happen. Without displacement, there is no torus. Displacement is perhaps best understood as movement along the z-axis (poloidal). Dynamism, or rotation, on the other hand, is movement around the z-axis (toroidal).

In the configuration of FIG. 2, the redirectors 290 are shaped like an array of little flat triangular fingers. As the engine rotates, the fingers of the redirector 290, fixed in place to the inside of the radial end-bracket, pushes the spheres 260 through the sphere tube 270 end-bends as the end-bends pass over the redirectors 290 (or the redirectors pass through the end-bend) during engine rotation. This heads the spheres 260 the other way to the redirectors 290 on the other end, which send them back again. And, the cycle is repeated. These redirectors 290 can come in many forms—fixed triangle fingers, Tele Screw finger, magnetic, electromagnetic, or electronic, to name a few InfinityScrew systems like the SkyWay have autonomous spokes and securing cuffs and do not require physical redirectors. Instead, in such configurations, the spokes and securing cuffs coordinate to transport the inertial information back and forth in vortex formation (or the torus pattern) along the axis.

The redirectors 290 are fixed to the engine-side (or inertial side) of the radial end-bracket assemblies at each end of the securing cuff on the inertia-facing side of the radial end brackets. The redirectors 290 assist with the displacement and re-ordering of inertia within the system. With each partial revolution of shaft 220, multiple spheres 260 are being redirected into tubes 270 going in the other direction. And, in certain embodiments this happens at both ends, simultaneously. With each redirection, information is removed from and added to each spoke tube. This enables ongoing simultaneous expansion and contraction of the system. While the redirectors may appear mirrored in some embodiments, they need not be mirrored in other embodiments. Rather, in such embodiments, spheres are to be in constant perpetual flow through the sphere tube matrix, regardless of the number of redirectors, redirector positioning, or the number of spoke tubes.

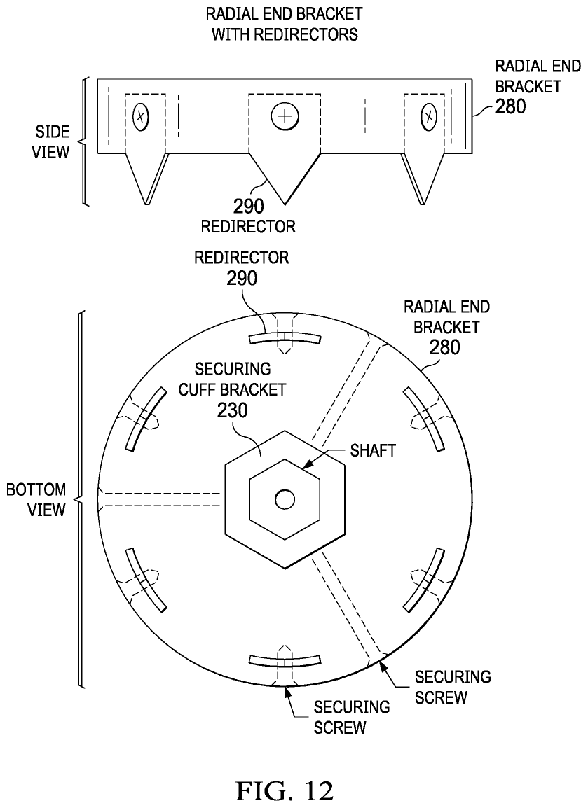

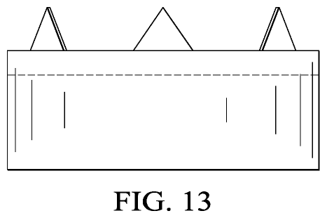

In particular embodiments, redirectors can occur in multiples, for example as shown in FIG. 13. However, this is not required in all embodiment embodiments. In the case of the InfinityScrew (see FIG. 12), where spheres are being redirected through the sphere tubes, a single redirector may not allow for continuous poloidal redirection. Accordingly, groupings of two or more redirectors are an effective fix. In particular embodiment, the redirectors have the redirector teeth per each of the redirectors.

In an InfinityScrew it is possible to redirect multiple spheres 260 per redirector 290 at one time. Regardless of the number of spokes or redirectors 290, in particular configurations, there are always redirectors 290 engaged redirecting spheres 260 during rotation of the InfinityScrew. Certain configurations of the InfinityScrew engine have at least 2 redirectors 290 at each end of the rotating securing cuff. They are positioned such that at least one set of redirectors 290 or the other is always actively redirecting the spheres 260 through the end-bends in the sphere tubes 270 during rotation of the securing cuff 250.

Particular configurations may have more spokes that engage more redirectors 290. More spokes enables the harnessing of more rotational inertia because such spokes can hold more spheres.

Particular configurations may also have more redirectors to assist displacement of rotational inertias per rotation. In certain configurations, this may be critical in designing IS engines because some IS engines, like screws and wheels, need to be able to activate with minimal rotation. For example, having more than two high-entropy spoke tubes may be the better way to design an automobile wheel. Certain configurations may have six or more high-entropy spoke tubes.

This “displacement” or “advancement” in the IS engine is essential for certain configurations because the rotational inertia in the system needs to keep moving—around the axis (toroidal), as well as along the axis (poloidal). In particular embodiments, the direction of toroidal and/or poloidal rotation may be reversed/reversible. In particular embodiments, the axis-charge may be a frequency transmitted through the axis by electric, electromagnetic, or optic means.

In IS engines with fixed spokes, no sphere 260 ever rests and each will forever be between the same two other spheres 260 in a continuous procession through the InfinityScrew spoke tube matrix. The InfinityScrew is always reorganizing its contents but maintaining the respective order of those contents indefinitely. The most productive and efficient toroidal systems maximize both dynamism (rotation) and displacement (advance).

A TeleScrew itself is a redirector of the rotational inertias generated by the InfinityScrew engine/system that it secures or holds on to, be it a CoolWheel or a SkyWay shaft or other. Going deeper within the TeleScrew, there are also internal redirectors. These internal redirectors redirect the rotation of its SuperScrew into linear drive, specifically extension and retraction from within

Tele Screw host tube/securing cuff bracket. Then, the actual SuperScrew that drives the Tele Screw has its own redirectors, which redirect the spherical inertias through the rotating InfinityScrew, generating the fundamental torus pattern, and activating the toroidal field. Behind that SuperScrew driver is an InfinityGenerator that redirects electrical inertia into the electromagnetic induction motor and the axis-circuit of the TeleScrew, which redirects space-time-gravity, thinning it to the point that the load at the end of the Tele Screw is weightless and easily maneuvered by the TeleScrew. Redirection follows purpose, and purpose is fundamental. The purpose is always for love or God or freedom or peace or happiness. The TeleScrew is essential in my inventions because it enables the poloidal redirection of rotational inertias within a multi-perspective, or fractal, system. When the SuperScrew driver at the bottom of the TeleScrew rotates, its screw-like exterior grabs the sphere drive bearings positioned in the long linear interior edges of the Tele Screw's often hexagonal securing cuff bracket (tubular.) The Tele Screw provides the poloidal (masculine-linear) aspect of the SnailScrew, which is the fundamental engine of the CircleScrew.

A CircleScrew, too, is driven by SuperScrews, but a CircleScrew converts rotational inertia to circular drive (also linear), thus enabling it to rotate itself or what it screws against. This rotation of one with respect to the other occurs when its threads turn against the triangular patterns of sphere bearings in concentric bearing brackets on the opposing circular surface. The SuperScrew provides the toroidal (feminine-circular) aspect of the SnailScrew.

Each SnailScrew is a torus redirector and combines both the linear and circular aspects of movement and perspective into one multi-functional multi-perspective redirector that does it all. SnailScrews redirect (or are redirected over) what they rotate against—sand, spheres, wheels, etc.

### Spheres (Blood or Life Force)

The spheres 260 are the anatomical equivalent of the lifeblood of an InfinityScrew engine. The pattern of rotational inertias the spheres 260 produce activate the waiting torus to take shape. Although spheres are describes as one “thing” that follow the infinity pattern, yet other “things” may also follow the pattern as will become apparent to one of ordinary skill in the art after review of the specification. As non-limiting examples, fluids (gas or liquids) and electrons may also be used for generating the essential torus movement pattern.

As the engine rotates around the axis, the spheres 260 move in procession through the sphere tubes 270, making an infinite infinity loop, thanks to the redirectors 290 at each end of the spinning engine, which keep them in perpetual poloidal motion during engine rotation. Redirectors 290 produce the poloidal aspect within the IS engine. A torus is BOTH poloidal and toroidal; poloidal is the advance (or displacement) of spheres/information along the axis, while toroidal is the rotation of spheres around the axis. Only together do they produce the angular momentum in the essential torus pattern—the toroidal convection pattern.

In particular embodiments, the spheres 260 are metal. Spheres are easy to work with, strong, and roll very easily. Their spherical geometry makes them torus-friendly. Again, virtually anything can lend its inertia to produce the essential torus activation pattern. Electrons work too.

### Spoke (Arm or Leg)

A spoke is the anatomical equivalent of an arm or leg. Spokes, like arms and legs, secure the hands or feet to the shoulders or pelvis. The arms or legs push out in the high-entropy phase of rotation, generating more rotational inertia, and they pull back in during the low-entropy phase of rotation, generating more rotational speed as the arms/legs retract closer to the rotating securing cuff. Visualize an ice skater pulling her arms in, spinning faster and faster as she does so. She is converting rotational inertia into rotational speed, just like a torus, by retracting her spokes inward towards her axis.

When a body (InfinityScrew) is secured by its collar, the rotary parts are the legs. When a body is secured by its pelvis, the rotary parts are the arms. When a body is secured by one half then the other then neither, the entire body can rotate freely around its axis, like the ice skater.

The fixed radial spoke that secures the sphere tube to the securing cuff and holds it in place, can be specialized into various blades for moving air, water, mixtures (matter).

There are two (2) basic types of spoke—high-entropy and low-entropy. They are both secured lengthwise atop the securing cuff. One holds the high-entropy sphere tube 270A outward away from the body while the low-entropy spoke holds the low-entropy sphere tube 270B inward, next to the body, as close to the spine as possible.

The high-entropy spoke secures high-entropy sphere tube 270A, which transfers the rotational inertias of the spheres from the front of the torus to the rear, during rotation. High-entropy spokes, which secure the high-entropy sphere tubes to the securing cuff, are often specialized for water and air propulsion and also serve as radial braces for the high-entropy sphere tubes. High-entropy can most often be related to the expansionary aspect of toroidal phases. Rotational inertia is its calling card. Extension is high entropy's modus operandi.

The low entropy spoke secures the low-entropy sphere tube 270B to the securing cuff. The low-entropy spokes enable the transfer of the rotational inertias low and flat against the securing cuff, from the rear to the front of the IS engine, during rotation of the securing cuff. The low-entropy spokes should be situated as close to the securing cuff as possible. Low-entropy can most often be related to the contractionary aspect of toroidal phases. Rotational speed is its calling card. Retraction is low entropy's modus operandi.

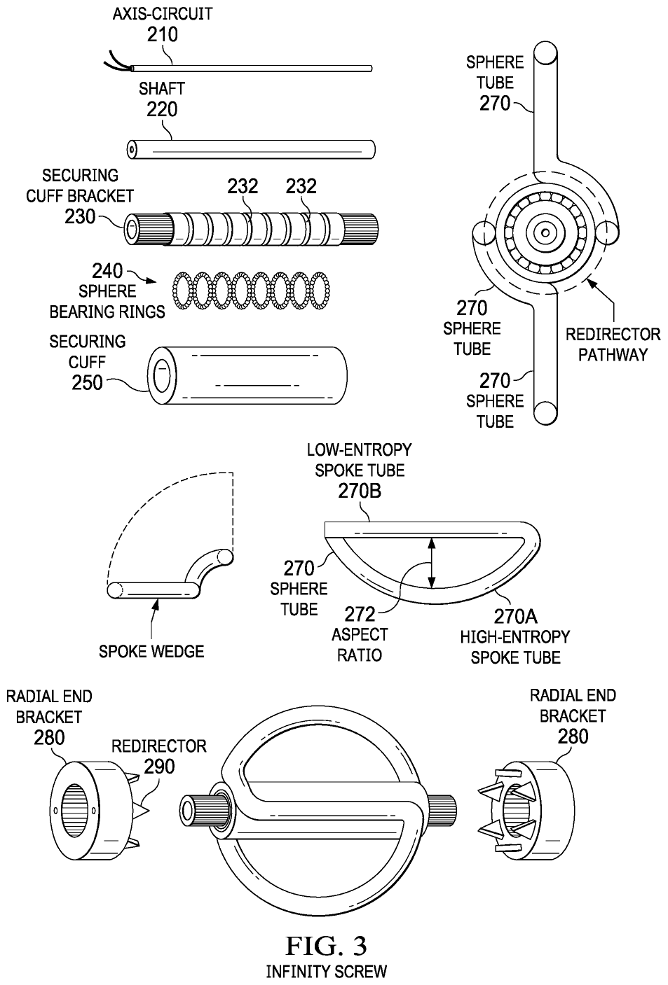

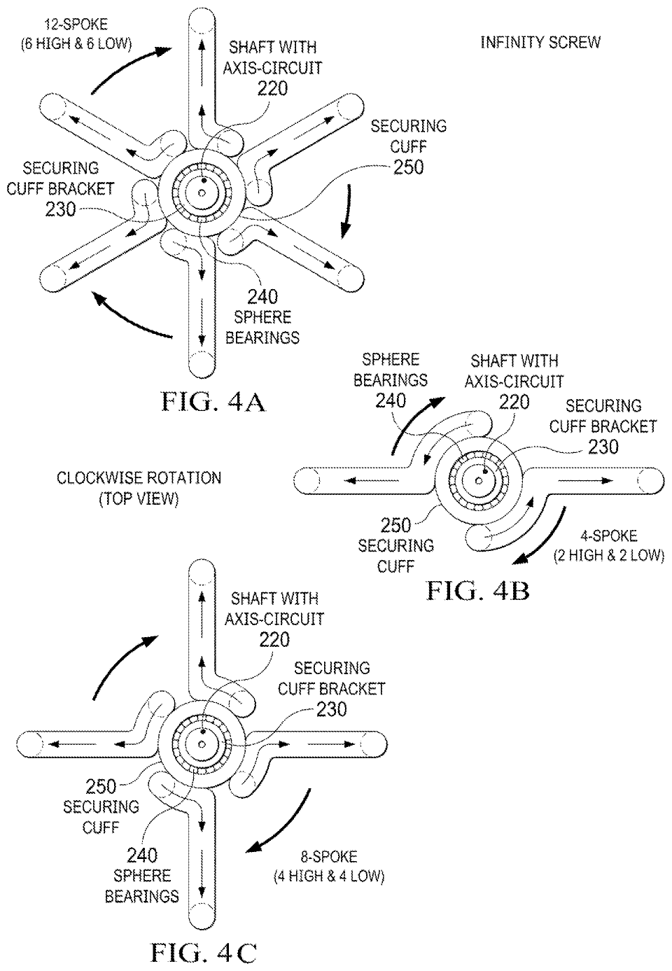

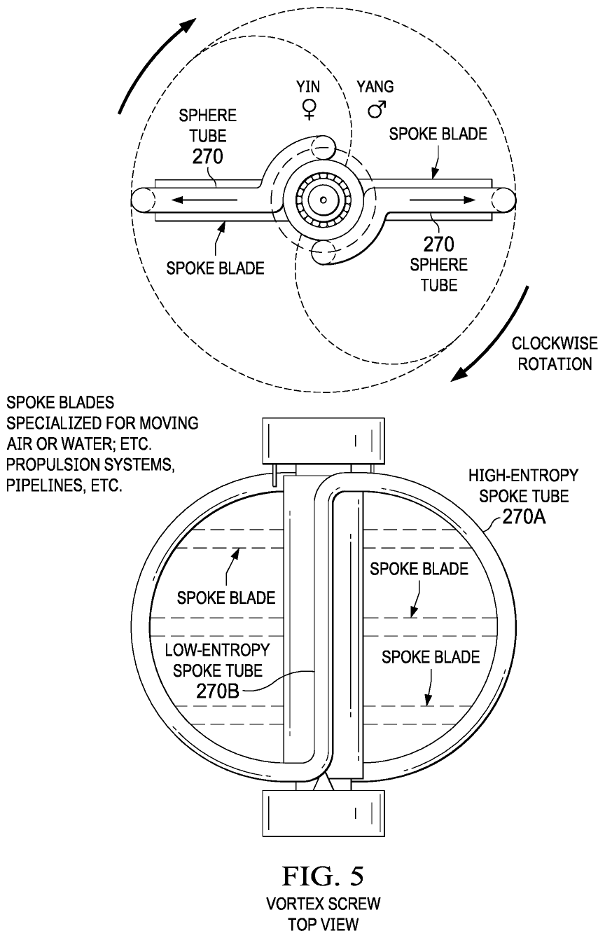

There are a number of ways that spokes can be secured to a securing cuff, including welded, fastened, molded, embedded, and machined groove. Yet other will become apparent after review of this specification. Spokes on some InfinityScrew systems are quasi-autonomous. FIG. 3A shows an IS with four spokes (two high-entropy and two low-entropy). FIG. 3B shows an IS with eight spokes (four high-entropy and four low-entropy). FIG. 3C shows an IS with twelve spokes (six high-entropy and six low-entropy).

A TeleScrew is a spoke of sorts and is often used as a high- and low-entropy spoke all-in-one because it can both extend and retract, depending on which phase is being experienced. It holds the rotational inertias out in high-entropy phase (expansion), or in, closer to the axis, during low-entropy phase (contraction). A TeleScrew extends and retracts, symbolic of the arm or leg, which does the same. This extension/retraction is poloidal in nature, whereas the turning and twisting of rotational inertias is toroidal in nature.

A CircleScrew is comprised of SnailScrews, each comprising two poloidal TeleScrew spokes and one toroidal SuperScrew driver.

### Sphere Tube (Hand or Foot)

The sphere tubes 270 are either the hands or the feet of the InfinityScrew, depending on the orientation of the body and by which end it is being held. Sphere tubes 270, like hands and feet, transfer inertial information back and forth between the poles of the axis, during rotation.

The sphere tubes 270 carry the spheres 260 through both expansionary and contractionary phases of the rotating InfinityScrew engine, containing and channeling the angular momentums through the sphere tube matrix that loops around the IS engine.

There are two phases in an IS engine—the expansion phase and contraction phase, also called high-entropy and low-entropy, respectively. The high- and low-entropy sphere tubes 270 cater to these phases. High- and low-entropy phases occur simultaneously and are ongoing.

The sphere tubes 270 are embedded lengthwise in or on the high-entropy and low-entropy spokes. As the IS engine rotates, fixed redirectors 290 on the inward side of the radial end bracket continuously redirect spheres into outgoing sphere tubes.

The high-entropy sphere tubes 270A have a phi-like curve shape and are embedded within, or secured to, the fixed high-entropy spoke. The high-entropy sphere tubes 270A smoothly convey spheres 260 from the front of the shaft to the rear (during rotation), where redirectors 290 move them into low-entropy sphere tubes 270B headed back to the front of the engine. This is ongoing. The low-entropy sphere tubes 270B are straight and secured as close to the securing cuff as possible. The low-entropy sphere tubes smoothly convey spheres from the rear of the IS engine to the front, during rotation.

The Circle Screw, which is actually a circular array of SnailScrews working in concert, is the anatomical equivalent of the InfinityScrew sphere tube—it is like a hand that grabs and twists inertia. Just like a Tele Screw is the anatomical equivalent of the InfinityScrew spoke—an arm that reaches out and enables the hand to hold the inertia out from the axis and then close to it.

A SnailScrew moves inertia around the z-axis, as well as along it, because it is both poloidal AND toroidal. SnailScrews are obviously fundamental. They generate rotation around the axis, but are also used to generate drive along it, as well. They provide an ideal balance of dynamism and displacement, or toroidal and poloidal, or feminine and masculine.

### End Cap (Skull or Tailbone)

The end cap(s), which is seen in other drawings, is the anatomical equivalent of the skull or tailbone. A skull or tailbone caps the end of the spinal cord and spinal column. The end cap screws/slides on and locks, securing the engine to the shaft 220 and covering the exposed end of the shaft 220 left sticking out from the end of the IS engine. The extended shaft and axis circuit are there to lengthen the force field along the shaft, or z-axis. This force field always extends out to the front and rear tips of the engine as it envelops and protects the IS engine or system from wear and fatigue. In alternative conjurations, the end cap can complete the axis-circuit. TeleScrew segments have a screw-on end cap that acts as the tailbone of that segment.

CircleScrews also utilize end caps, and can share the end cap with the InfinityScrew engine-system they encircle.

### Engine Bracket (Hips-Legs-Feet or Shoulders-Arms-Hand)

The “engine bracket” could be thought to include everything not moving, including the shaft 220 and the securing cuff bracket 230. One may think of the engine bracket as all that holds and secures the rotating or moving part to the wing, structure, machine, etc.

Engine brackets come in many specialized shapes and sizes and enable rotation of the InfinityScrew from below the collarbone or from above the pelvis, depending on the directional orientation and positioning of the engine. Most InfinityScrews are reversible but have a primary direction of travel. This primary direction of travel determines the “top” or “front” of the engine. Anatomically, nothing is different, aside from the orientation of the engine with respect to its securing point. If held from the pelvis of the InfinityScrew, then the spokes and sphere tubes are the arms and hands, while the engine bracket is the hips, legs, and feet of the engine, securing it to the structure.

The FanJet and InfinityGenerator are examples of InfinityScrew engines that are held from the pelvis. However, if held from the top of the engine, or by the collarbone, then the spokes and sphere tubes become the legs and feet, while the engine bracket becomes the shoulders, arms and hands of the engine, holding it to the structure. The StratoFan and Tele Screw are examples of engines that are held from the top, or the front. The SnailScrew is held by both the collarbone and the pelvis. Which is which depend on the direction of travel. For ultimate simplicity, remember that the engine bracket is and includes everything that is fixed or non-rotating, while the IS engine is rotating. This includes the structure to which the IS engine is attached. The shaft is part of the engine bracket, too, as are the radial end brackets 280 and the securing cuff bracket 230.

A Tele Screw engine bracket is the fixed host tube (securing cuff bracket) in which the TeleScrew segment resides and works. TeleScrew segments house other TeleScrew segments, as well. Multiple TeleScrew segments embedded within larger TeleScrew segments—hexagons within hexagons. A TeleScrew can also be an engine bracket for something else, like a SnailScrew or an AnchoredAuger.

A CircleScrew engine bracket is the fixed ring-like cavity in which the CircleScrew is secured. As with all three anatomies, the engine brackets can be thought to include everything that is fixed or not moving, with respect to its respective securing cuff.

### HALO (Mind)

The Helper Avatar Locator Observer (HALO) handles all of the computing and acts as the communications center of, for, and between every InfinityScrew engine and system. Systems are simply collections of multiple other InfinityScrew engines, just like body organs are collections of smaller cellular systems. HALO oversees all aspects of an IS engine's operation. HALO is the encouraging hand that watches over the IS engine and guides it true.

HALO monitors all engine systems (axis charge, rotation speed, computing and processing in multiple dimensions, electromagnetic induction systems, and everything else) and communicates with other HALOs in its network. Groupings of InfinityScrews working together all operate under a larger or “upper” HALO. Collections of “lower” HALOs are guided by an HALO, which serves as a director, as of a symphony. This hierarchy of taskmasters smoothly and efficiently manages the multitude of precise operations that need to occur within the more complex systems. HALO is most often positioned in the electromagnetic induction assembly.

In particular configurations HALO utilizes quantum computing. HALO also communicates with other HALOs from other systems and sub-systems, as well as with the torus kind central HALO system in the cloud (VacuumLock). VacuumLock is the repository for InfinityScrew-systems strategy—how the machines play, problem-solve, and collaborate, learning to shave off time or to complete complex tasks more quickly and/or safely. Sharing the learning of the systems with other systems is like creating an open-source program for the machines.

HALO is ubiquitous throughout the IS engines and systems and is often headquartered in the electromagnetic induction assembly. This provides the trans dimensional-processing framework necessary for the outer processor to know what's happening on the inside and for the inner processor to know what's happening on the outside. Communication between the inner and the outer is a must and it happens through HALO, which has a mind in each world.

A TeleScrew HALO is located in its bi-conical EM induction assembly, between the SuperScrew and the InfinityGenerator.

A CircleScrew is made up of SnailScrews, each with its own HALO. Above this, the CircleScrew has a larger HALO that oversees the operation of its SnailScrew sub-systems. This more encompassing HALO coordinates with other more encompassing HALO's to enable the multiple systems to work in concert, just like the fingers on a hand.

### Electromagnetic Induction Assembly (Seat or Saddle) for HALO

The electromagnetic (EM) induction assembly is the control seat or saddle for HALO, which is the avatar (mind and director) of the InfinityScrew engine. The EM induction assembly is shaped like a saddle—conical or tubular or half-pipe—and straddles the torso of the engine, like a saddle on a horse. The EM induction assembly can also assume the shape of a belt, cap, ring, or other. The EM induction assembly straddles the lower body of the rotating InfinityScrew engine, spurring the hips and rear to activate the horse (engine), initiating direction and then charging the animal forward. The EM induction assembly is the means for axis-circuit charge, EM induction operation, power generation, and it contains a battery for initiation. The EM induction assembly is sometimes a linear motor and works like magnetic levitation (maglev) to rotate the InfinityScrew.

The tubular, conical, or partially conical electromagnetic induction motor-generator-battery assembly, is often positioned near the rear end of the engine and is mounted to the engine-bracket, which secures the engine to the structure. The electromagnetic induction motor turns the engine in the desired direction to get the toroidal pattern started. The EM induction assembly is also a brake for slowing the engine's rotation speed and inertia.

One will notice that the electromagnetic induction assembly serves multiple purposes. For example, in some of the propulsion IS engines, the electromagnetic induction assembly is used to funnel and compress air around the rear of the engine. In other IS engines like the CoolWheels, the electromagnetic induction assembly is just above the engine. Like a fender, the EM induction assembly protects the engine bracket from flying debris.

A TeleScrew has a bi-conical electromagnetic motor-generator-battery assembly near the base of the TeleScrew. The EM induction assembly of a TeleScrew serves two closely-situated InfinityScrews. The leading InfinityScrew is the SuperScrew driver screw, which extends the Tele Screw. The trailing InfinityScrew is the InfinityGenerator that runs constantly, providing power to initiate the SuperScrew driver while producing the space-time thinning force field that enables what it lifts to be lifted and managed with ease. The end cap of the Tele Screw could also contain part of the EM induction assembly, perhaps the battery.

A CircleScrew typically has a half-pipe or saddle-like EM induction assembly. CircleScrews solve the problem by disengaging one or more of the inactive SnailScrews and actively engaging it only as a generator (pulled away from the sphere bearing drive path).

### Specialized Anatomies (Fins-Claws-Teeth-Lips-Skin-Scales-Etc.)

Torus engines can be specialized for almost any task. Wings are specialized spokes for moving air. Fins are specialized spokes for moving water. Boring bits are teeth. Augers and TubeScrews are lips, mouth, throat, intestine, tail, and anus.

### Additional InfinityScrew Details

### Aspect Ratio

The aspect ratio 272 makes it possible for life/blood/information to flow in both directions along the axis, simultaneously, without head-butting or stalling out. The aspect ratio 272 is the space time necessarily left “open” or free from occupation by rotational inertia—like a neutral or no-fly zone. The aspect ratio is vital for both high- and low-entropy rotational inertia regions to coexist in dynamic inertial harmony.

Aspect ratios will vary from one toroid to the next, depending on the task and the space available for the toroid to fit within. Other factors aside, as long as there is an aspect ratio, or a void space between the spherical inertias moving in opposite directions along the shaft (during rotation), a toroidal IS engine will work fine.

The aspect ratio 272 enables self-feeding, self-organization, and self-balance, and prevents the system from stalling out, headbutting itself, or having no place to “flow” into. A torus always has space to flow in to. And if it doesn't, it can usually make the space required to accommodate more, through greater rotation speed and faster advance (or displacement) along the z-axis. The greater the toroidal aspect ratio—the greater the difference between expansion and contraction potentials. Similarly, the water spinning in the vortex is spinning faster around the center than the exterior. All layers of the vortex share the same axis circuit or vortex line, enabling them to spin at different speeds without disrupting each other.

### Phi-Space

The phi-space (or life space) is the space contained within the aspect ratio, or the space between the low-entropy and high-entropy sphere tubes (the doughnut-like region within). Think of the Phi-space as the volume of area that the doughy part occupies; the part around the hole. In particular configurations, the phi-space is protected force field space. In particular configurations, the phi-space is the container in which creation happens, whether it be the creation of life, products, food, thrust, or torque.

### Zero-Space

The zero-space is the space contained between the axis (vortex line) and the low-entropy region. Think of it as the hole of the doughnut. The zero-space, like the phi space, resides within the protective force field. The zero-space is where reorganization (and disintegration) happens. While the InfinityScrew (sphere-class) engines-systems do not utilize the zero space, InfinityMatrix systems, which utilize electromagnetic space-time implosion field generator coils to produce the Torus pattern and unlock the toroidal portal, do utilize the zero-space. WaterWashers and other InfinityMatrixes use the zero-space to re-organize matter. TelePorters use the zero-space to access the singularity for travel. As long as whatever is traveling through the zero-space is contained within a tube, or attached to something that passes uninterruptedly through, it will make it through to the other side, more re-organized than before. Whatever is loosely thrown into the zero-space field is gone forever. This makes it great for disposing of highly toxic or radioactive wastes. There's no trace left. All of it gets thrown into the zero-space and is disintegrated or reorganized in the singularity.

### InfinityMatrix

The InfinityMatrix is a torus pattern generator for liquids, mixtures, and electrons. The InfinityMatrix utilizes tubes or wires to channel inertias through a curvilinear (circular plus linear) infinity pattern, similar to that of the InfinityScrew. The combination of poloidal and toroidal movement through the matrix of spiral spoke tubes or wires produces the rotational inertias and the essential torus pattern, defining the vector field of the resultant torus electromagnetic force field.

### Anatomical Analogies of InfinityMatrix

The InfinityMatrix has the same basic anatomical analogies as the InfinityScrew engine, save for the defenses referenced below.

### Spiral Design of Spokes is a Replacement for Spherical Bearings (Vertebrae or Ribs)

The spiraling shape of the spokes replaces the securing cuff sphere bearings as the

20 anatomical equivalent of vertebrae or ribs in the InfinityMatrixes because they produce the same rotation effect as the bearings do in the InfinityScrews. Instead of bearings that enable the securing cuff to rotate around the securing cuff bracket, the spokes of the InfinityMatrix produce rotation by their spiral curvilinear design/configuration, thereby necessitating no bearings for rotation. This spiral spoke design is possible because we are using tubes and wires for liquids and electrons, which can flow around the end-curves without requiring more than a top or bottom set of redirectors, verses redirectors at both ends, as is the case with the InfinityScrew engines.

### Securing Cuff (Shoulder-Scapula or Hip Socket)

The anatomy of the InfinityMatrix is fundamentally the same as that of the InfinityScrew. The most noticeable difference is that the InfinityMatrix securing cuff does not rotate as it does with an InfinityScrew. An InfinityMatrix securing cuff doesn't rotate because it doesn't need to. What's important is that the rotational inertias (liquids and electrons) are rotating within the securing cuff; producing the essential angular momentums that activate the torus. The securing cuff is meant to contain and channel the rotational inertias and enable them to flow through the InfinityMatrix system. The curvilinear spiral-wound spokes illustrate the torus pattern and make it possible for the fluids or electrons to travel a prescribed and contained curvilinear pathway through the InfinityMatrix system, generating the essential angular momentums along the way.

### Redirectors/Hearts and Stomachs

InfinityMatrix redirectors redirect inertia to keep it moving in poloidal fashion throughout the system, keeping the system alive (angular momentum) during rotation. InfinityMatrix redirectors, which include ScrewBall valves and Tube Screw pumps (for driving fluid), or electronic switches and amplifiers (for driving coils), redirect inertia into and out of the InfinityMatrix system, versus simply recirculating it within the system, as is the case with InfinityScrew redirectors, which always add poloidal drive.

InfinityMatrix redirectors invariably always add curvilinear drive because the pathway of tubes or wires is already curvilinear (and both toroidal and poloidal) InfininityMatrix tubes and wires can bend and flow their information around bends without requiring active redirection at the ends of every spoke, as is required with InfinityScrews. This means comparatively fewer redirectors, including sometimes none of them in one of the two radial end-brackets of the InfinityMatrix. One radial end-bracket might contain all of them.

### Liquids or Electrons (Lifeblood Inertia)

The liquids or electrons moving through the Infinity tube/wire matrix are producing rotational inertias (or angular momentums) as they go. Those rotational inertias are the lifeblood of the InfinityMatrix because they activate the torus field and enable it to animate.

### Spoke (Arm or Leg)

InfinityMatrix spokes are the forms that hold the inertia-carrying tubes or wires in place. In the case of the InfinityMatrix, those spokes and their spoke tubes/wires take on a curvilinear or spiral shape, incorporating both the toroidal and poloidal aspects in the spoke so that no rotation of the securing cuff is necessary. In some sense, spiral spoke combines the leg and foot, or the masculine and feminine qualities, respectively. The masculine and feminine together produce curvilinear.

### Spoke Tube/Wire (Hand or Foot)

An InfinityMatrix can use tubes or wires to produce the torus vortex pattern with liquids or electrons. These spoke tubes or wires are the anatomical equivalent of the hands or feet of the InfinityMatrix, depending on the orientation of the body and by which end it is being held.

The spiral spoke tubes or wires of the InfinityMatrixes don't require external poloidal redirectors, like those of the InfinityScrew because the spiral shape of the tubes (or wires) of the InfinityMatrix, along with the uninterrupted “flow” that occurs through the end-bends of the tubes or wires, provides a fixed curvilinear path that is both toroidal AND poloidal. This pattern unlocks the torus.

For every high-entropy spoke tube that is seen on the exterior there is a corresponding low-entropy spoke tube near the interior.

### Electromagnetic Induction Assembly (Seat or Saddle) for HALO Avatar

The electromagnetic induction assembly is the control seat or saddle for HALO—the helper avatar that oversees the operation of the engine and its systems. The electromagnetic induction assemblies of InfinityMatrixes are located within the radial end-bracket(s); more often located around the hips or torso of the InfinityMatrix. The radial end-brackets can extend outward to, but not beyond, the high-entropy spokes of the InfinityMatrix. In some InfinityMatrixes, the electromagnetic induction assembly can be located within the aspect ratio space of the InfinityMatrix—within the Phi-space. The electromagnetic induction assembly may also house the InfinityMatrix fluid pumps and/or InfinityCoil signal generators, etc.

### Additional Details of InfinityMatrix

The InfinityMatrix has the same basic additional details as the InfinityScrew engine, save for the differences referenced below.

### Aspect Ratio

InfinityMatrixes are often utilized in conjunction with InfinityCoils, occupying the aspect ratio and the gap spaces of the coil. The triple/trinity infinity pattern would seem to be the most basic for an InfinityMatrix, residing in the 9-3-6 gap space of the InfinityRing coils. These 3 nodal points are 120 degrees apart from each other.

### Engine Diameter, Rotation Speed

Depending on its function, an InfinityMatrix can have any number of spiral spokes and/or circuits. Some InfinityMatrixes, like those of the InfinityCoils, have a base 9-point wind and at least 3 separate circuits. InfinityMatrixes, like the tube matrix in the WaterWasher, have a multitude of spoke tubes residing in the gap spaces of the InfinityRing coil in which it is embedded. The number of spoke tubes is dependent upon the number of 9-3-6 gap spaces in the InfinityRing coil. More reorganizing and filtering may be better served with more spokes, not fewer.

The redirectors on the InfinityMatrixes are either ScrewBall valves, if it's a tube matrix, or electronic switches, if it's a wire matrix. ScrewBall valves redirect liquid in and out of the infinity tube matrix, always in sync, maintaining the dynamic equilibrium of the tube matrix's rotational inertias. InfinityCoils, which are wire matrixes, have electronic switches for redirectors, delivering a 3-phase electrical signal to the InfinityCoil in a heartbeat-like rhythm.

Tube matrixes like the WaterWasher have a filtration system on several of the high-entropy spoke tubes. It is designed after the feather or the baleen of a whale. It traps particulate and augers it away with a TailScrew auger system. Particulate can either be collected or permanently disposed of on site. The FeatherFilter is another anatomical piece, perhaps the kidneys and/or the liver.

The InfinityMatrix is a vanilla tube- or wire-winding pattern. It is used as a template design for InfinityCoils, WaterWashers, SpringSprings, and more.

Some embodiments of the InfinityMatrix have straight axis, while others have a spiral axis, or SpiralSpine.

### InfinityScrew

The InfinityScrew may be considered to be in a class of sphere-driven torus pattern generator with a subsystem of none because it is more primal. In particular configurations, the InfinityScrew is a reactionless gyroscopic engine (a reactionless drive) that converts rotational inertia into linear, circular, or curvilinear movement or drive. The InfinityScrew is the most basic of all InfinityScrew engines. The InfinityScrew looks like the Phi symbol and is the basic engine from which all other sphere class InfinityScrew engines originate. The InfinityScrew is one of the fundamental building blocks of all InfinityScrew engines and systems and is therefore a primary focus of this disclosure because most everything else is built around and upon it.

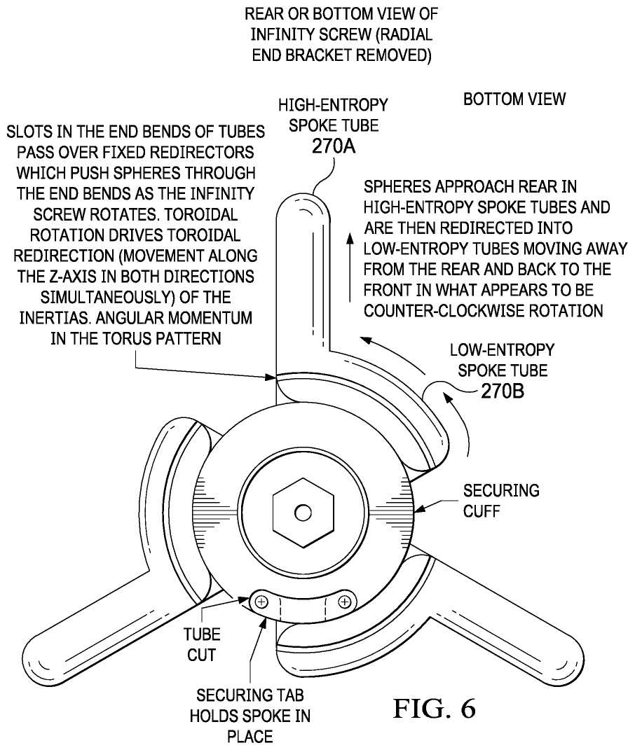

FIG. 6 shows a bottom view of the InfinityScrew, radial end bracket removed.

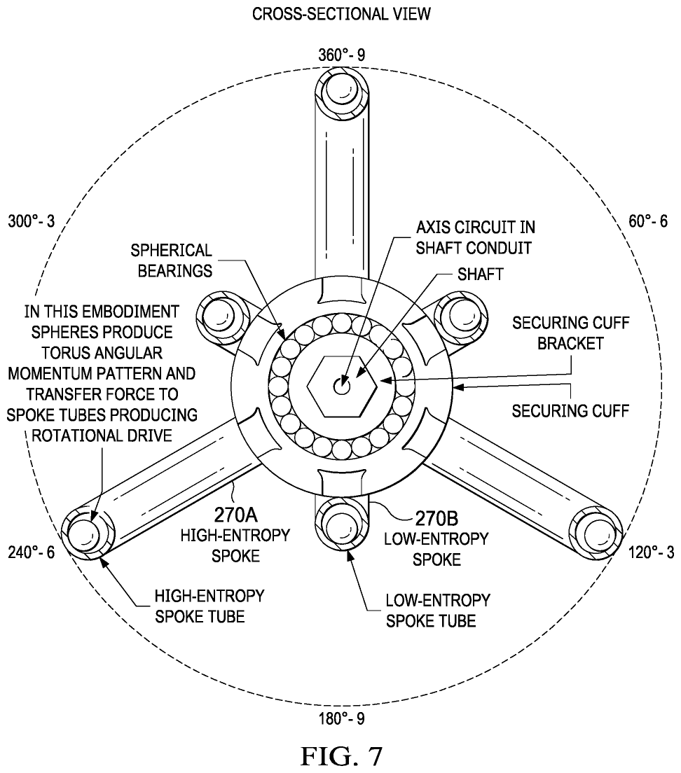

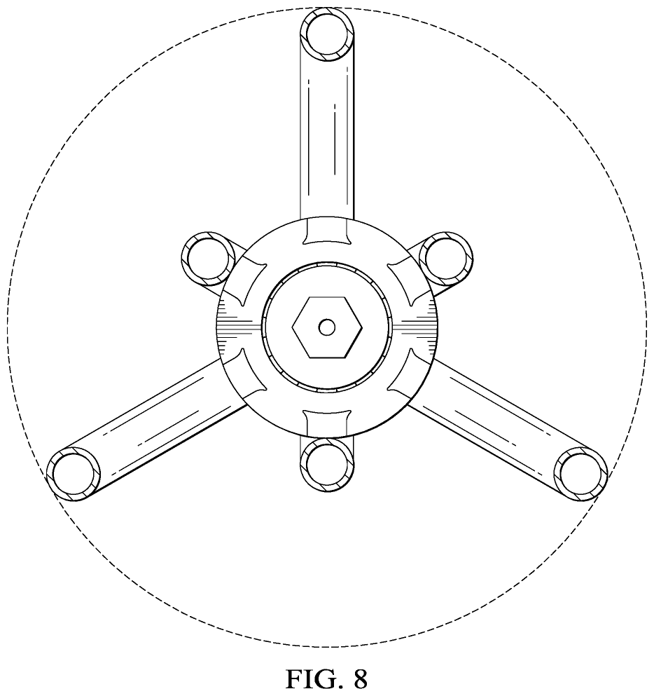

FIG. 7 shows a cross-sectional view of the InfinityScrew; FIG. 8 shows a cross-sectional view of the InfinityScrew.

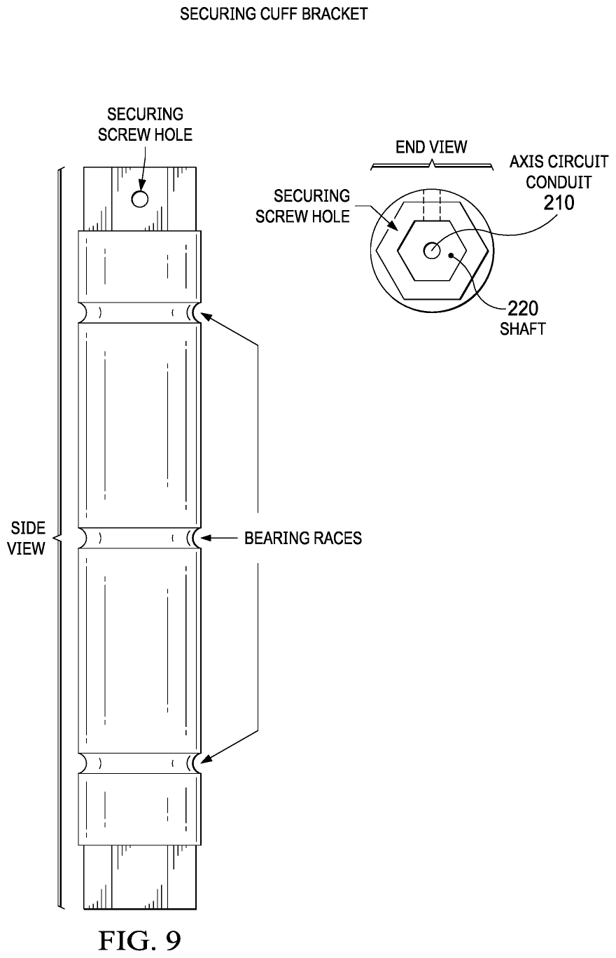

FIG. 9 shows a side view of the InfnityScrew securing cuff bracket.

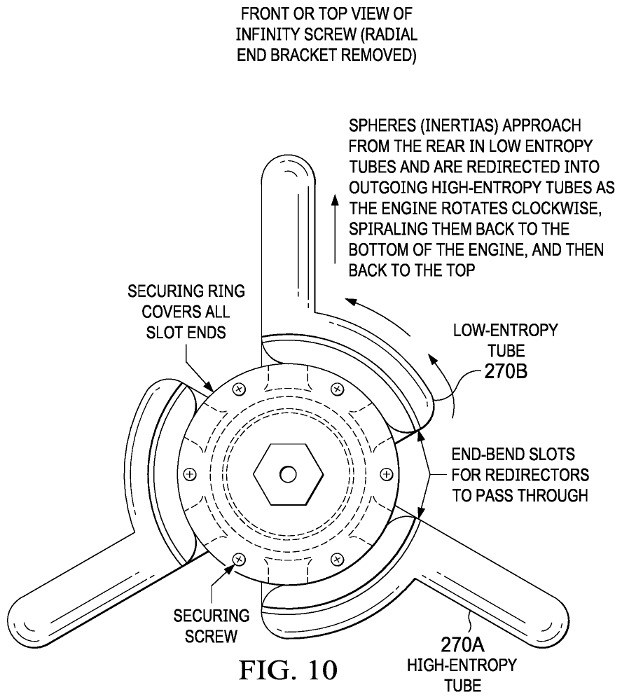

FIG. 10 shows a front or top view of the InfinityScrew, radial end bracket removed.

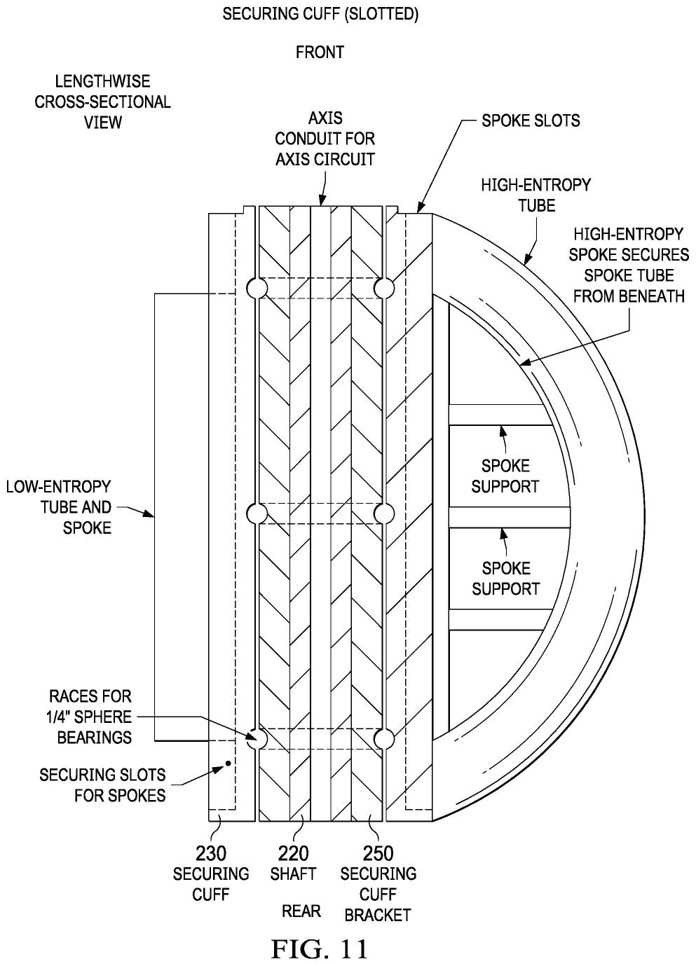

FIG. 11 shows a lengthwise cross-sectional view of the InfnityScrew engine securing cuff and securing cuff bracket.

FIG. 12 shows the radial end bracket with redirectors; FIG. 13 shows a multi-tooth redirector.

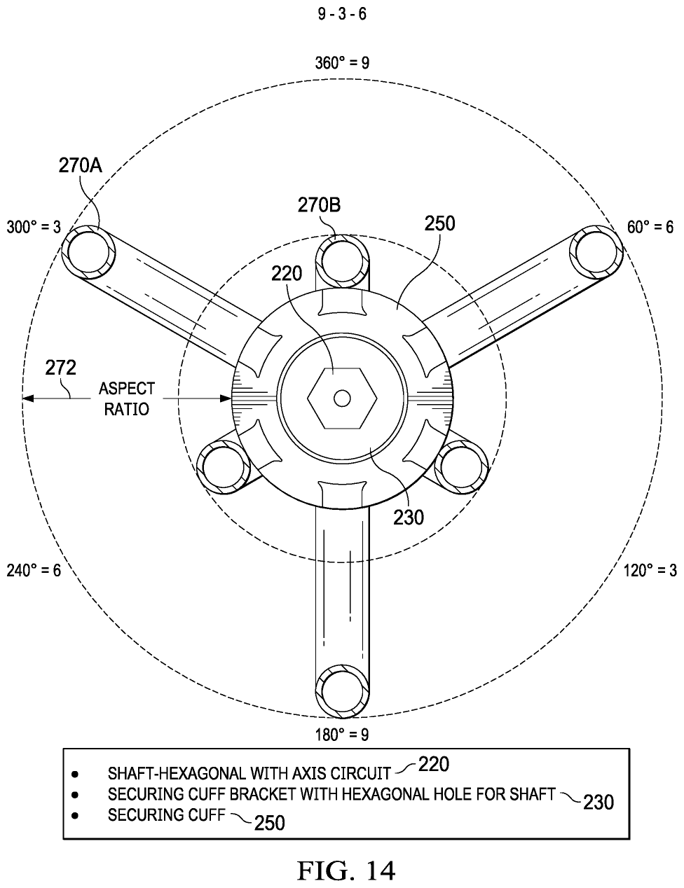

FIG. 14 shows a cross-sectional view of the InfinityScrew.

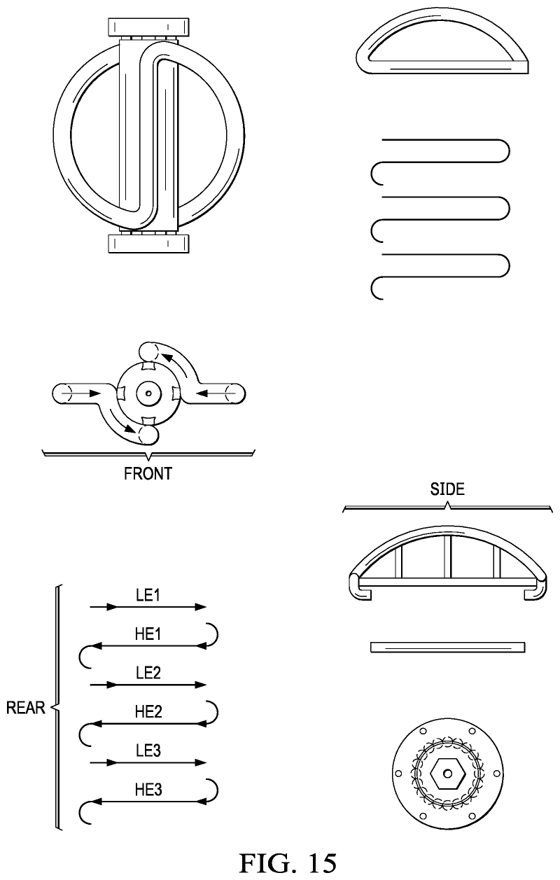

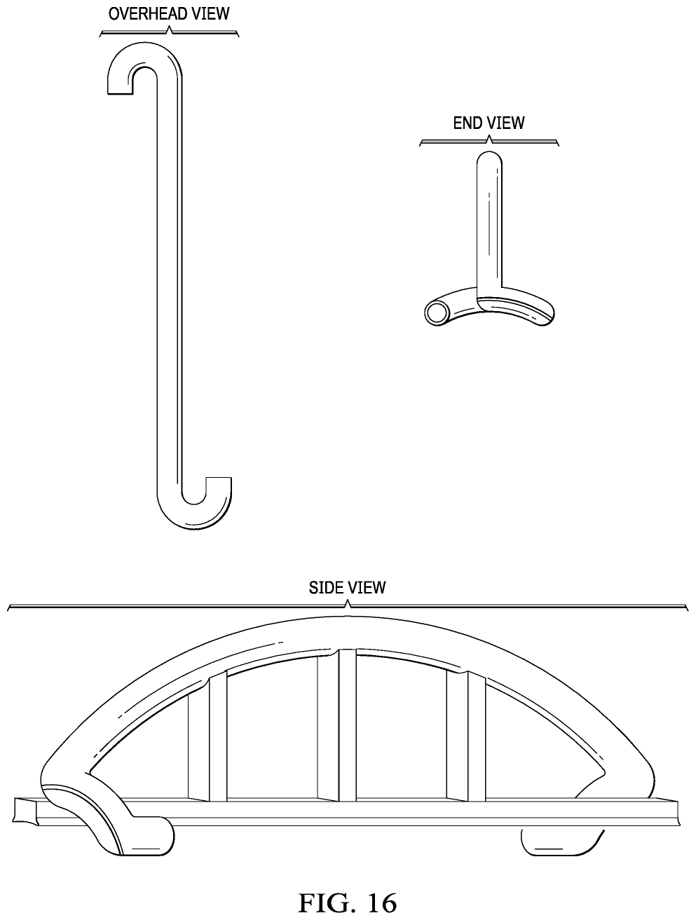

FIGS. 15 and 16 show spoke-tube segments.

It will be understood that well-known processes have not been described in detail and have been omitted for brevity. Although specific steps, structures and materials may have been described, the present disclosure may not be limited to these specifics, and others may be substituted as it is well understood by those skilled in the art, and various steps may not necessarily be performed in the sequences shown.

While this disclosure has described certain embodiments and associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. method of moving an item in a torus-like pattern, the method comprising:
moving an item poloidally along a path with reference to a torus grid; and
at least partially moving the item toroidally along the path with reference to the torus grid such that when the item substantially moves around a revolution around the torus grid when viewed from a cross section cut across the poloidal direction of movement, the item also moves poloidally.

2. The method of claim 1, wherein a portion of the poloidal movement with reference to the torus grid is non-linear and another portion is linear.

3. The method of claim 1, wherein the path of movement of the item does not cross another path of movement when viewed from a cross-section cut across the toroidal direction of movement.

4. The method of claim 1, wherein the item is at least one sphere flowing through tubes that follow the path.

5. The method of claim 1, wherein the item is a plurality of spheres flowing through tubes that follow the path.

6. The method of claim 1, wherein the item is at least one electron.

7. The method of claim 1, wherein the item is fluid.

8. The method of claim 1, wherein multiple items are simultaneously moved along the path both toroidally and poloidally such that when the items substantially move around a revolution around the torus grid when viewed from a cross section cut across the poloidal direction of movement, the items also move poloidally.

9. The method of claim 1, wherein the item follows a continuous path repeating a revolution around the torus grid when viewed from a cross section cut across the poloidal direction of movement approximately that is 120 degrees apart from a prior revolution.

10. A system for moving an item in a torus-like infinity pattern, the system comprising:
a channel for moving an item poloidally along a path with reference to a torus grid, wherein the channel in at least partially moves the item toroidally along the path with reference to the torus grid such that when the item substantially moves around a revolution around the torus grid when viewed from a cross section cut across the poloidal direction of movement, the channel also moves the item poloidally.

11. The system of claim 10, wherein a portion of the channel with reference to the torus grid is non-linear and another portion is linear.

12. The system of claim 10, wherein channel does not cross another channel of movement when viewed from a cross-section cut across the toroidal direction of movement.

13. The system of claim 10, wherein the item is at least one sphere flowing through the channel that follows the path.

14. The system of claim 10, wherein the item is a plurality of spheres flowing through the channel that follows the path.

15. The system of claim 10, wherein the item is at least one electron.

16. The system of claim 10, wherein the item is fluid.

17. The system of claim 10, wherein multiple items are simultaneously moved along the path both toroidally and poloidally such that when the items substantially move around a revolution around the torus grid when viewed from a cross section cut across the poloidal direction of movement, the items also moves poloidally.

18. The system of claim 10, wherein the channel follows a continuous path repeating a revolution around the torus grid when viewed from a cross section cut across the poloidal direction of movement approximately 120 degrees apart from a prior revolution.
